(19) United States
(12) Patent Application Publication
(10) Pub. No.: US 2008/0120699 A1
(43) Pub. Date: May 22, 2008

(54) Method and system for assessing and mitigating access control to a managed network

(75) Inventor: Paul R. Spear, Yamhill, OR (US)

Correspondence Address: BINGHAM MCCUTCHEN LLP, 2020 K Street, N.W., Intellectual Property Department, WASHINGTON, DC, 20006, US

(73) Assignee: McAfee, Inc.

(21) Appl. No.: 11/650,411

(22) Filed: Jan. 8, 2007

Related U.S. Application Data
(60) Provisional application No. 60/859,499, filed on Nov. 17, 2006.

(51) Int. Cl. G06F 21/20; G06F 15/173

(52) U.S. Cl. 726/4; 709/225

(57) ABSTRACT

A method, system, and computer program product for controlling access to a network that adds a new type of policy and new types of mitigation based on profiles of historical information about what the device did since last connected. This historical information will be used to create a historical based risk profile to determine whether or not to grant a device access to the network. A method for controlling access to a network comprises the steps of detecting that a device is attempting to obtain access to the network, examining historical information relating to behavior of the device while the device was not accessing the network, and determining whether to grant access to the network based on the historical information.

### BACKGROUND OF THE INVENTION

1. Field of the Invention

The present invention relates to assessing and mitigating access control to a managed network when previously trusted devices detach and rejoin the network by using historical behavior profiling.

2. Description of the Related Art

In a managed access environment, when managed devices leave the network, access-control and policy-enforcement software products currently use limited static data to determine whether to allow reconnection to return and how to mitigate before reconnection. The current art of those products do not take into account what the device may have done while disconnected as a way to determine how much risk is involved and how extensive mitigation must be when reconnecting to the network.

The current art in compliance policy and mitigation generally falls in the following areas. (one, many, or all of these may be in use depending upon the system and settings used for compliance).
1. Is the machine running the proper security software that matches the required policy? (Av, VPN, firewall, etc).
2. Is the above software configured correctly to match required policy?
3. Is the above software configured updated to match required policy?
4. Is the OS on the Device a permitted version?
5. Is the OS on the Device running required security updates as specified by policy.
6. Is the OS on the device configured to meet certain testable policies (such as password complexity, or screen saver enabled at 5 minutes idle with password, etc.)
7. Is other list of specified software running on the device the correct versions?
8. Is that list of specified software running its correct list of updates as required by policy?
9. Does the device have certain prohibited items (for example a second network interface connected to a non-trusted network)?
10. Mitigation generally consists of attempts to set settings to match policy or attempting to update the offending component to apply required updates that would make the item compliant.

These conventional techniques are all checks which test the current state of the device being checked and do not take into account historical information about the machine. A need arises for a technique that offers improved access control over conventional techniques.

### SUMMARY OF THE INVENTION

A method, system, and computer program product for controlling access to a network that adds a new type of policy and new types of mitigation based on profiles of historical information about what the device did since last connected. This historical information will be used to create a historical based risk profile to determine whether or not to grant a device access to the network.

A method for controlling access to a network comprises the steps of detecting that a device is attempting to obtain access to the network, examining historical information relating to behavior of the device while the device was not accessing the network, and determining whether to grant access to the network based on the historical information. The historical information may relate to at least one of use of elevated privileges on the device, installation of software on the device, use of specified tools on the device, use of one or more protocols on the device, access to Internet domains on the device, temporary disabling of security software on the device, modification of the settings of security software on the device, modifying specified system settings on the device, attachment of external devices to the device, use of removable media with the device, information that the device was never turned on or used while disconnected, modification of an executable type file on the device, and receipt of a security notice from one or more security processes on the device.

The method may further comprise the steps of identifying at least one risk factor based on the historical information, assigning a score to each identified risk factor, and generating a final risk score from the scores assigned to each identified risk factor. The determining step may comprise the step of denying access to the network if the final risk score is greater than a threshold. The method may further comprise the steps of performing a mitigation process for each identified risk factor, determining whether the mitigation process was successful for the risk factor, and eliminating the score for the risk factor if the mitigation process was successful. The mitigation process may comprise at least one of running at least one deep security scans on the device using updated versions of the security software for the device, running at least one deep security scans of only the changed files/setting of the device using updated versions of the security software for the device, quarantining the device until manual mitigation can be applied, and tightening a security policy for the device to a higher level based on the score but still allowing the device some access to the managed network.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a managed access network, in which the present invention may be implemented.

FIG. 2 is an exemplary block diagram of a managed access network, in which the present invention may be implemented.

FIG. 3a is an exemplary flow diagram of a portion of a process of access control, according to the present invention.

FIG. 3b is an exemplary flow diagram of a portion of a process of access control, according to the present invention.

FIG. 3c is an exemplary flow diagram of a portion of a process of access control, according to the present invention.

FIG. 4 is an exemplary block diagram of a remote user device, in which the present invention may be implemented.

FIG. 5 is an exemplary block diagram of an access control/risk assessment system 500, in which the present invention may be implemented

### DETAILED DESCRIPTION OF THE INVENTION

A managed access network environment involves network resources managing the connection and disconnection of devices to and from the network. When managed devices seek to reconnect to the network, access-control and policy-enforcement software determines whether to allow to reconnect and whether any mitigation of the device is needed before the reconnection is allowed. In the present invention, a historical risk profile of a device that is trying to reconnect is generated while the device is disconnected. This profile may be combined with existing static methods to determine a risk score for allowing reconnection to a network and to determine whether additional higher impact mitigations should be attempted before allowing reconnection of the device or rejecting the connection.

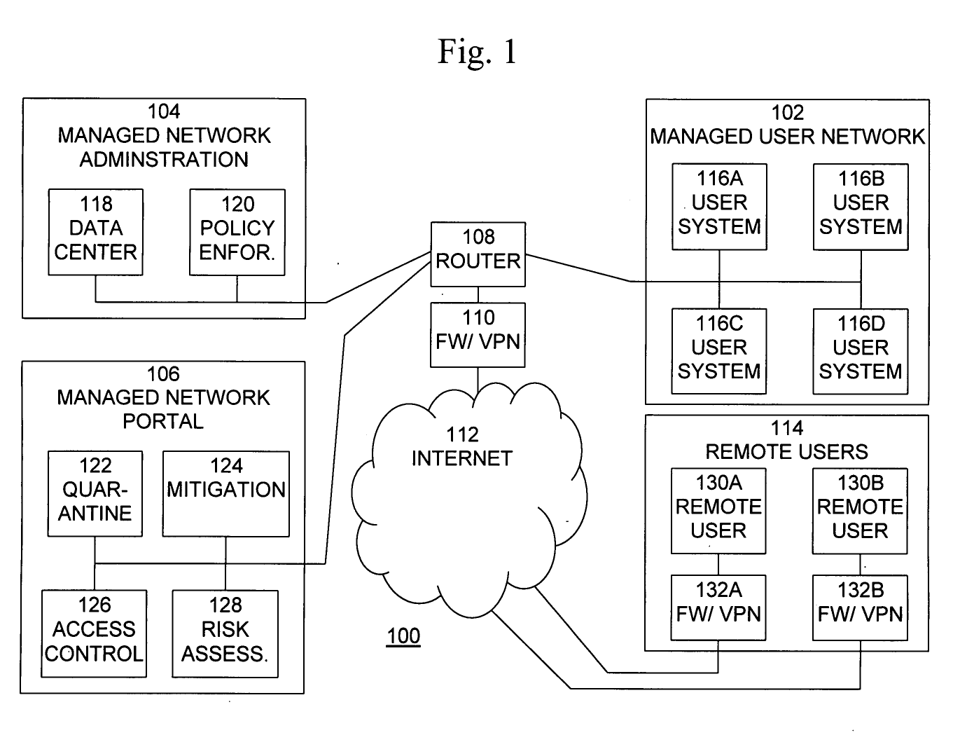

An example of a managed access network 100 is shown in FIG. 1. Network 100 includes managed user network 102, managed network administration 104 and managed network portal 106. Managed user network 102, managed network administration 104 and managed network portal 106 are typically communicatively connected by one or more routers 108. The network formed by managed user network 102, managed network administration 104 and managed network portal 106, and router 108 is typically communicatively connected via firewall/virtual private network gateway 110 to the Internet 112. Remote users 1 14 may connect to the network formed by managed user network 102, managed network administration 104 and managed network portal 106, and router 108 via the Internet 112.

Managed user network 102 includes a plurality of user systems, such as user systems 116A-D, which are communicatively connected by a network such as a local area network. Manage network administration 104 includes functions such as a data center 118 and a policy enforcement function 120. Data center 118 stores necessary and critical data used by the network, as well as other data that is desirably stored with high reliability. Policy enforcement function 120 enforces network policies on the systems that are connected to the network. Such policies may include security and system configuration policies. Enforcement functions may include identifying systems that are out of compliance with the network policies and performing mitigation on such systems to bring them back into compliance.

Managed network portal 106 provides functions such as quarantine functions 122, mitigation functions 124, access control 126, and risk assessment functions 128. Access control 126 may include functions such as authentication, authorization and audit. Authorization may be implemented using Role based access control, access control lists or a policy language such as XACML. Risk assessment functions 128 analyze devices that are connected to the network or that are attempting to connect to the network to determine the risk factors associated with continuing connection of the device or allowing connection of the device. In the present invention, risk assessment functions 128 use historical information about a device that is attempting to connect to the network, as well as static factors, in order to determine the risk involved. This is described further below. Quarantine functions 122 provide the capability to isolate devices attempting to connect to the network or to isolate particular files or data traveling through the network or located on devices connected to or attempting to connect to the network. Typically, such devices or files are quarantined based on detected risk conditions, such as the file having a virus signature, etc. Mitigation functions 124 provide the capability to correct conditions, such as risk conditions, in devices connected to the network or attempting to connect to the network. Mitigation functions 124 may work in conjunction with risk assessment functions 128 in order to mitigate risks identified by risk assessment functions 128 and lower the resulting overall risk.

Router 108 is a computer-networking device that forwards data packets across a network toward their destinations, through a process known as routing. A typical network, such as that shown in FIG. 1, may include many routers in order to communicate data throughout the network. Although not shown, the network may also include one or more switches, which also communicate data throughout the network.

Firewall/virtual private network gateway 110 provides both firewall and virtual private network functions. A firewall is a logical barrier designed to prevent unauthorized or unwanted communications between sections of a computer network. A firewall prevents some communications forbidden by the security policy, analogous to the function of firewalls in building construction. Typically, a firewall is implemented as a packet filter to controlling traffic between different zones of trust. In the example shown in FIG. 1, the zones of trust include the Internet 112 (a zone with no trust) and an internal network (a zone with high trust). The ultimate goal is to provide controlled connectivity between zones of differing trust levels through the enforcement of a security policy and connectivity model based on the least privilege principle.

A virtual private network (VPN) is a private communications network often used within a company, or by several companies or organizations, to communicate confidentially over a publicly accessible network. VPN message traffic can be carried over a public networking infrastructure (e.g. the Internet) on top of standard protocols, or over a service provider's private network with a defined Service Level Agreement (SLA) between the VPN customer and the VPN service provider.

Remote users 114 include one or more devices, such as devices 130A and 130B that are connected to, or which are attempting to connect to network 100, whether directly (not shown) or via the Internet 112. Remote users 114 may include devices that only access network 100 via the Internet 112 and may include devices that are sometimes connected directly to network 100 and that are sometime disconnected from network 100. Typically, such devices connect to the Internet 112 via their own firewall/virtual private network functions 132A and 132B.

It is to be noted that the network and devices shown in FIG. 1 are merely examples. The present invention contemplates implementation in any type or configuration of network using any type and configuration of devices.

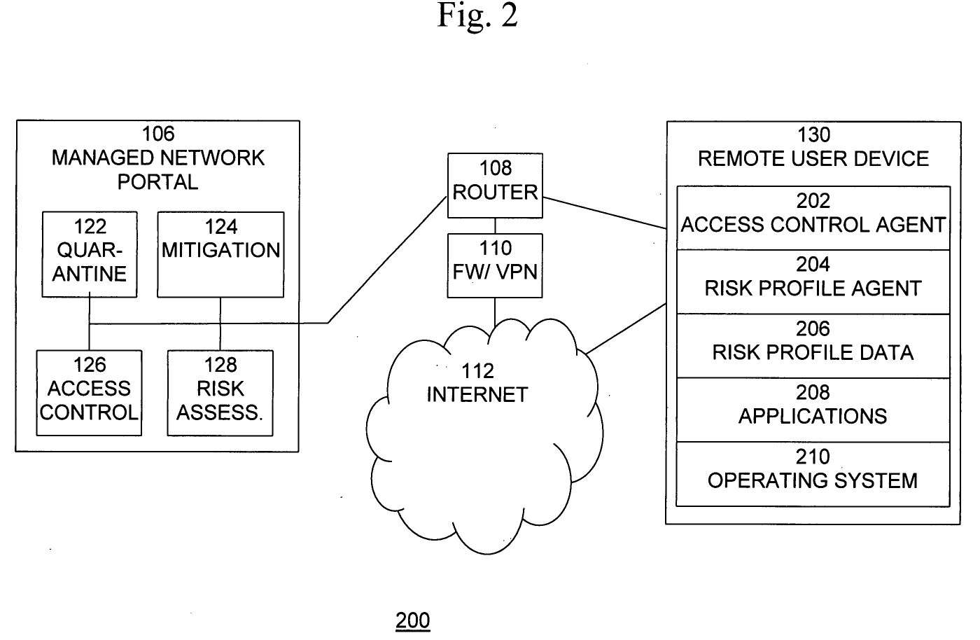

A more detailed example of a network 200 in which the present invention may be implemented is shown in FIG. 2. Network 200 includes managed network portal 106 and remote user device 130. Managed network portal 106 includes quarantine functions 122, mitigation functions 124, access control 126, and risk assessment functions 128. Remote user device 130 includes access control agent 202, risk profile agent 204, risk profile data 206, applications 208, and operating system 210. Remote device 130 may include devices that only access network 200 via the Internet 112 and may include devices that are sometimes connected directly to network 200 (via router 108) and that are sometimes disconnected from direct connection with network 200.

Access control agent 202 examines and controls the security policies that control the security behavior of remote user device 130. Risk profile agent 204 monitors the contents and behavior of remote user device 130 and stores data relating to the risk factors that are to be considered when remote user device 130 attempts to access the network. Risk profile data is data stored by risk profile agent 204 that relate to risk factors. Data 206 may be purely historical data, such as logs of connections made by remote user device 130, logs of Web sites visited, logs of software downloaded and/or installed, etc. Data 206 may alternatively, or in addition, include actual measures or estimates of risk factors computed by risk profile agent 204. Applications 208 include software used to perform other functions on remote user device 130. Operating system 210 provides overall system functionality.

In addition, although the example in FIG. 2 shows access control agent 202 and risk profile agent 204 as separate software objects, both functions may be incorporated into one software object, or they may be incorporated into multiple software objects, including more than the two software objects shown in the example. The present invention contemplates any implementation or division of functionality of these functions.

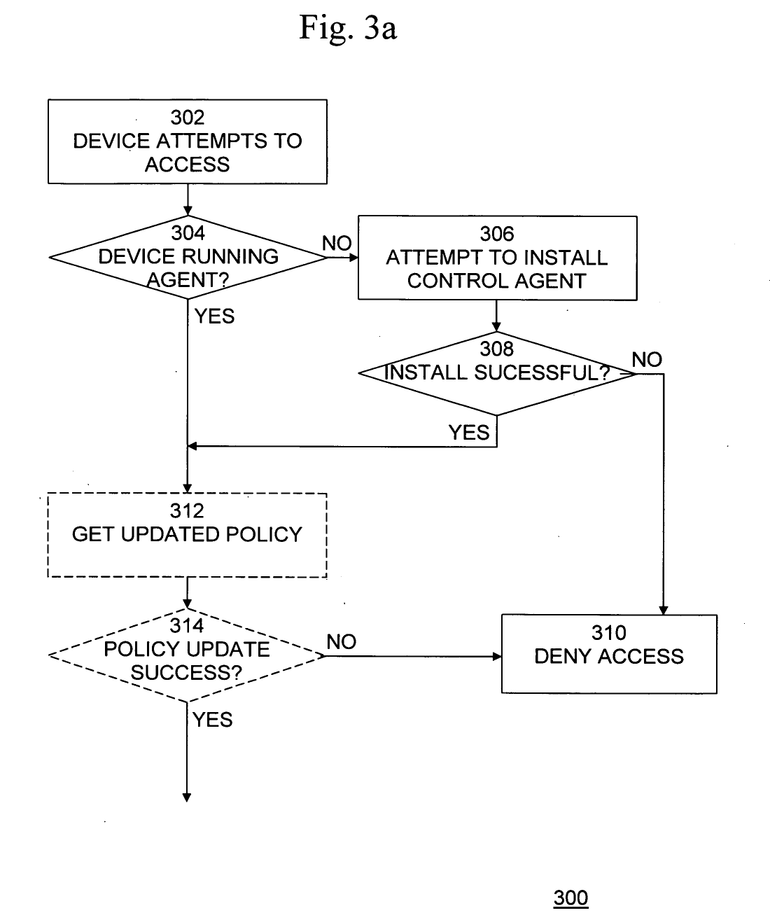

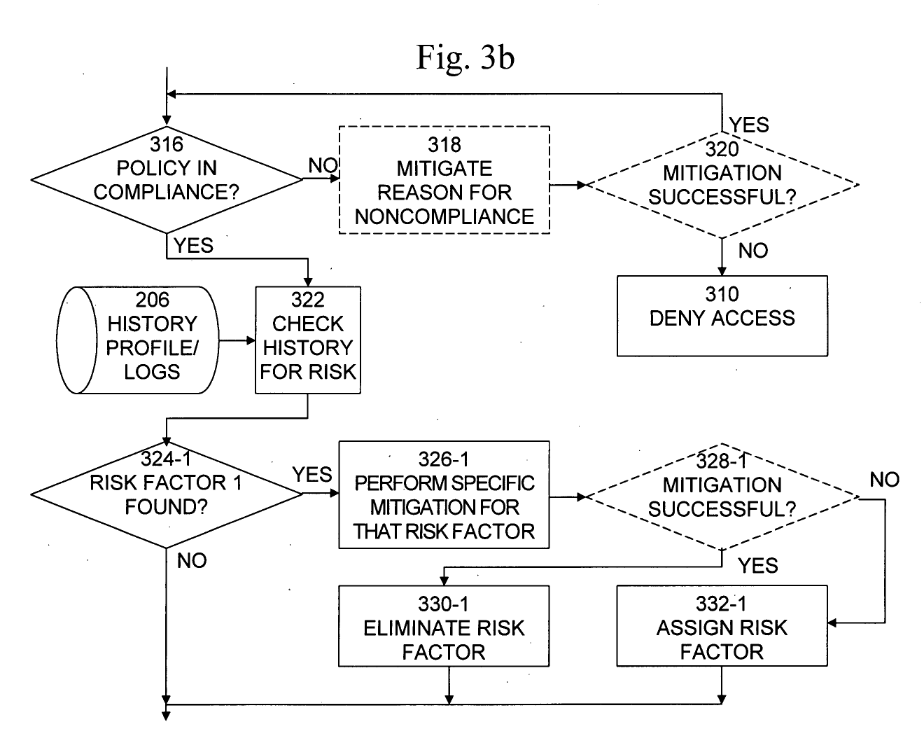

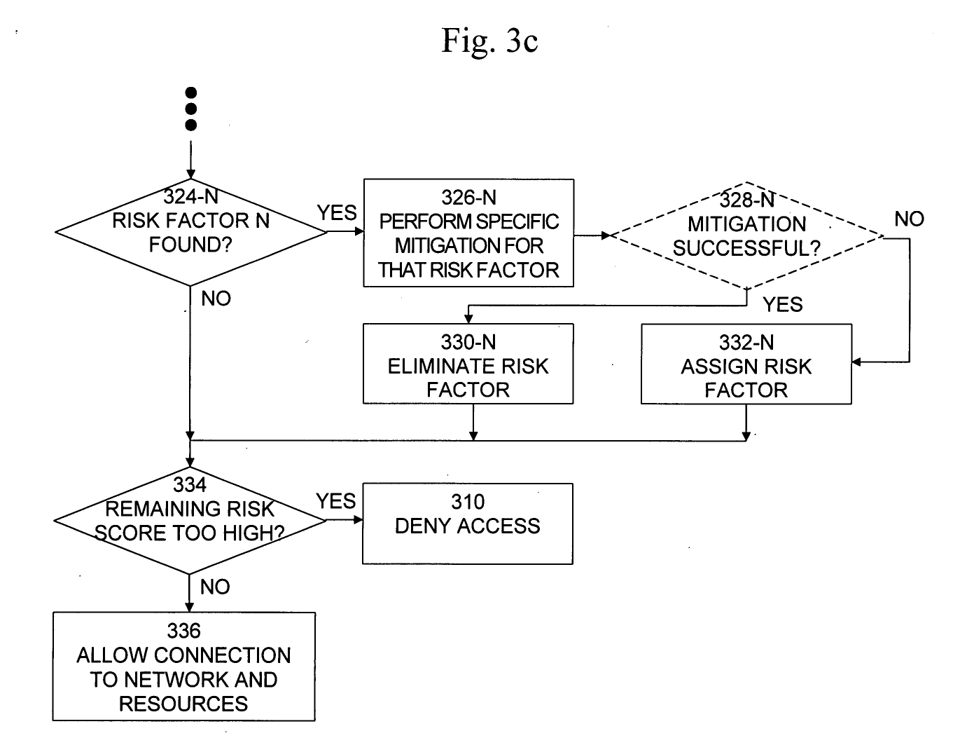

As described above, risk assessment functions 128 analyze devices that are attempting to connect to the network to determine the risk factors associated with allowing connection of the device using historical information about the device. Mitigation functions 124 may work in conjunction with risk assessment functions 128 in order to mitigate risks identified by risk assessment functions 128 and lower the resulting overall risk. An example of a process of risk assessment/mitigation 300 is shown in FIGS. 3a-c. It is best viewed in conjunction with FIG. 2.

Process 300 begins with step 302, in which a device, such as a remote user system 132A or 132B, attempts to connect to or to obtain access to network 100. In step 304, a network gatekeeper function, such as access control function 126 or risk assessment function 128, examines the device that is attempting to obtain access to determine whether or not an access control agent 202 and/or a risk profile agent 204 is running on the device. Typically, the gatekeeper function challenges the device by attempting to communicate to the access control agent 202 on the device. If the access control agent 202 does not respond, then there is no agent is running on the device, and the process continues with step 306, in which the managed network attempts to install and launch the missing agent on the device. In step 308, it is determined whether or not the install was successful. If not, the process continues with step 310, in which the device is denied access to the network.

If, in step 304, it was determined that the device was running the required agent, or in step 308, it was determined that the required agent was successfully installed, then the process continues with steps 312 and 314, which are optional. In step 312, the access control agent 202 running on the device attempts to get and install updated policy information. In step 314, it is determined whether the updated policy information was successfully obtained and installed. If not, then the process continues with step 310, in which the device is denied access to the network. If so, or if steps 312 and 314 are not performed, the process continues with step 316, shown in FIG. 3b.

In step 316, the access control agent 202 determines whether the policy in effect on the device that is attempting to obtain access to the network is in compliance with the policy requirements of the network. If not, then the process continues with steps 318 and 320, which are optional. In step 318, mitigation methods are used to attempt to bring the non-compliant device into compliance. In step 320, it is determined whether the mitigation has been successfully performed. If so, then the process loops back to step 316, in which it is again determined whether the policy in effect on the device that is attempting to obtain access to the network is in compliance with the policy requirements of the network. If, in step 320, it is determined that the mitigation has not been successfully performed, or if in step 316, it is again determined that the policy is not in compliance, then the process continues with step 310, in which the device is denied access to the network.

If, in step 316, it is determined that the policy is in compliance, then the process continues with step 322, in which the history profile/logs 206 are. examined. In steps 324-1 to 324-N, the risk factors present in history profile/logs 206 are identified. Once each risk factor is identified, mitigation of the risk factor may be attempted and a weighting or score of the risk factors is assigned. For example, in step 324-1, it is determined whether a particular risk factor, for example, risk factor 1, has been found. If so, then the process continues with step 326-1, in which a mitigation process specific to the identified risk factor is performed. In step 328, it is determined whether the mitigation process was successful in mitigating the identified risk factor. If the mitigation was successful, then the process continues with step 330-1, in which a score or weighting for the risk factor is eliminated from the final risk score. If the mitigation was not successful, then the process continues with step 332-1, in which a score or weighting for the risk factor is assigned to the remaining risk score.

After the completion of step 330-1, 332-1, or, if in step 324-1, it the risk factor was not found, the process continues with similar steps for each remaining risk factors, finally concluding with steps 324-N through 332-N, shown in FIG. 3c, for risk factor N. After identifying and attempting to mitigate each risk factor, the process continues with step 334, in which it is determined whether the remaining risk score is greater than a threshold. If the remaining risk score is greater than a threshold, then the process continues with step 310, in which the device is denied access to the network. If the remaining risk score is less than or equal to the threshold, then the process continues with step 336, in which the device is granted access to the network.

The process for examining the history profile/logs 206 may be part of the access control agent 202, the risk profile agent 204, or another process on the device 130, or the process for examining the history profile/logs 206 may be external to the device 130. The examination and scoring of the historical record may be ongoing on the device 130 (dynamic), it may happen periodically, or it may happen in response to certain actions, such as when the device 130 connects to the Internet or when the device 130 connects to the managed network. The scoring process may be centrally configurable or it may be hard-coded into software, depending upon the implementation. Likewise information used in the scoring process, such as the risk factors of significance and the weights or scores to assign to particular risk factors may be configurable, centrally configurable, or hard-coded. Scoring can be used to allow or disallow access or it can be used to just alert processes external to this invention as to the likelihood of risk. Likewise, mitigation may be based either on aggregate score of all historical behaviors or on each type of behavior monitored separately.

In implementing the present invention, there are one or more agents running on a managed device. Each agent monitors one or more behaviors of said device and or its user over time and stores a historical record of those behaviors. Each monitored and scored behavior may have its own agent, or multiple behaviors may be monitored by one or more agents, or all behaviors may be monitored by one agent. Examples of monitored and scored behaviors may include
1. Use of elevated privileges on the device (such as having logged in as an admin or power user while disconnected).
2. Installing software on the device (such as executables, interpreted code, active x, scripts, etc.).
3. Use of certain tools on the system (running ftp, telnet, remote desktop connection, regedit, Instant Messaging, etc).
4. Use of one or more protocols (downloading files, receiving via IM, logging on to unmanaged networks, using dialup, etc).
5. Accessing Internet domains (this could just log the domains for later analysis or could dynamically rate each site using an agent that checks each site as visited).
6. Temporarily having disabled any of the previously installed security software.
7. Modifying the settings of any security software.
8. Modifying other system settings determined to be worth monitoring.
9. Attaching external devices to the device (such as flash readers, external drives, Bluetooth modems, etc).
10. Using removable media with the device.
11. Information that the device was never turned on or used while disconnected.
12. Having modified any file considered to be an executable type.
13. Having received security notice from one or more security processes on the device while disconnected (such as a virus detected and cleaned notification or a notice that something attempted to exploit a particular buffer overflow, or that the device had blocked too many bad password attempt to login remotely, etc.)
14. Any other behavior that can be monitored by a software agent that could be used to help determine risk.
15. A log of all files and/or settings changed to allow a off device scoring process the ability to do a targeted analysis later for threats that could apply to those items when reconnecting to the managed LAN.

Examples of mitigation methods that may be used individually or in any combination may include:
1. Automatically running one or more deep security scans of the device using updated versions of the security software for that device.
2. Automatically running one or more deep security scans of only the changed files/setting of the device using updated versions of the security software for that device.
3. Quarantining the device until manual mitigation can be applied.
4. Automatically tightening the security policy for the device to a higher level based on the score but still allowing the device some access to the managed network.

An example of a scenario of use of the present invention is as follows: A laptop is trusted by the managed network and is up to date with all policies. The laptop is taken off of the network and is on the road for three days. The compliance agent (and/or one or more helper agents) on the laptop notices that the system has been disconnected and begins to monitor and record information about how the laptop is used for those three days building a historical risk assessment profile. The user knows how to use admin privileges on his laptop and installs new software on his box from a risky site. The compliance agent notes the use of administrative login and records it in the risk assessment profile. It also records the domains or IP addresses of the web sites the laptop visits and records them in the risk assessment profile. It also logs that the setup process was run and that one or more executable files were installed on the laptop. On the second day he is gone the anti-virus vendor updates its virus definitions to include the software that the user installed as a threat and the managed network receives those definitions. The night before returning to the office the user hibernates his laptop with the new malware already running on his machine. When the system is hibernated the compliance agent notes that its state when being hibernated was still disconnected from the managed network. The next morning he connects his laptops cable to the companies network and turns on the laptop which resumes from hibernation with the malware already loaded. The gatekeeper for the network notices the connection and proceeds to challenge the connection attempt using the networks policy. Part of the check determines that the anti-virus definitions are out of date so they apply the update to the laptop. Another check queries the historical risk assessment profile that has been generated while the laptop was away from the managed network. Each element of the historical risk assessment profile can be given a score that can be used to determine if additional mitigations need to be performed before allowing the laptop on the managed network. Using the weightings and the historical information the gatekeeper decides to submit the list of websites visited by the laptop to a website rating service to determine if any of them are know to be dangerous. Also since the system has had new software installed on it and was hibernated before the connection it tells the compliance agent to do a full scan of the laptop before allowing connection. The scan detects the malware and disables it and 50 minutes later when the scan completes the gatekeeper allows the laptop access to the managed network. Although the user was delayed, the user finally is allowed to log into the central customer database but this time thanks to the historical risk assessment profile the malware was prevented from carrying out its threat.

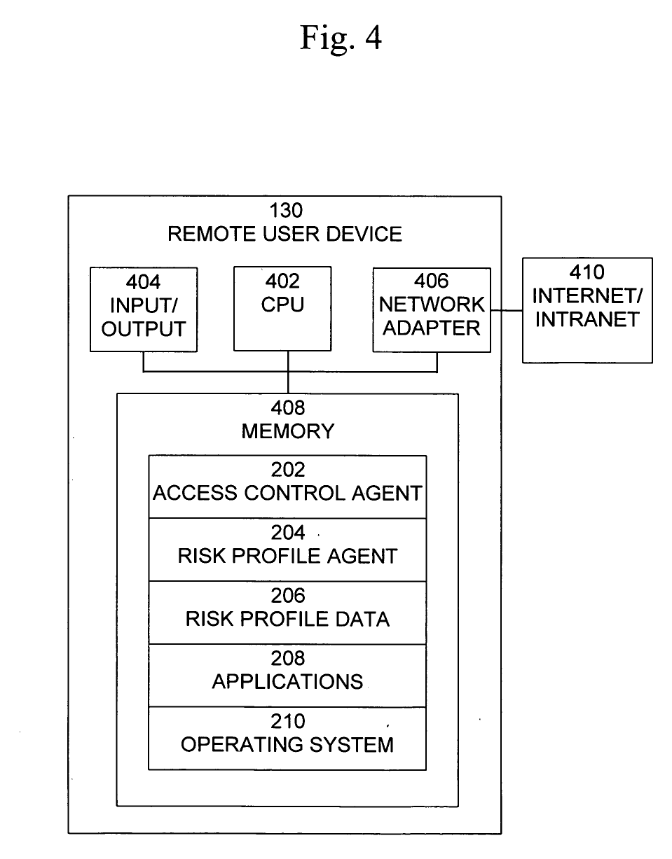

A block diagram of an exemplary remote user device 130, in which the present invention may be implemented, is shown in FIG. 4. Remote user device 130 is typically a programmed general-purpose computer system, such as a personal computer, workstation, server system, and minicomputer or mainframe computer. Remote user device 130 includes processor (CPU) 402, input/output circuitry 404, network adapter 406, and memory 408. CPU 402 executes program instructions in order to carry out the functions of the present invention. Typically, CPU 402 is a microprocessor, such as an INTEL PENTIUM® processor, but may also be a minicomputer or mainframe computer processor. Although in the example shown in FIG. 4, remote user device 130 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which remote user device 130 is implemented on a plurality of networked computer systems, which may be single-processor computer systems, multi-processor computer systems, or a mix thereof.

Input/output circuitry 404 provides the capability to input data to, or output data from, remote user device 130. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces remote user device 130 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of remote user device 130. Memory 408 typically includes electronic memory devices, such as random-access memory (RAM), which are capable of high-speed read and write operations providing direct access by the CPUs 402A-N. Additional memory devices included in remote user device 130 may include read-only memory (ROM), programmable read-only memory (PROM), electrically erasable programmable read-only memory (EEPROM), flash memory, electro-mechanical memory, magnetic disk drives, hard disk drives, floppy disk drives, tape drives, optical disk drives, etc.

Memory 408 includes access control agent 202 examines and controls the security policies that control the security behavior of remote user device 130. Risk profile agent 204 monitors the contents and behavior of remote user device 130 and stores data relating to the risk factors that are to be considered when remote user device 130 attempts to access the network. Risk profile data is data stored by risk profile agent 204 that relate to risk factors. Data 206 may be purely historical data, such as logs of connections made by remote user device 130, logs of Web sites visited, logs of software downloaded and/or installed, etc. Data 206 may alternatively, or in addition, include actual measures or estimates of risk factors computed by risk profile agent 204. Applications 208 include software used to perform other functions on remote user device 130. Operating system 210 provides overall system functionality.

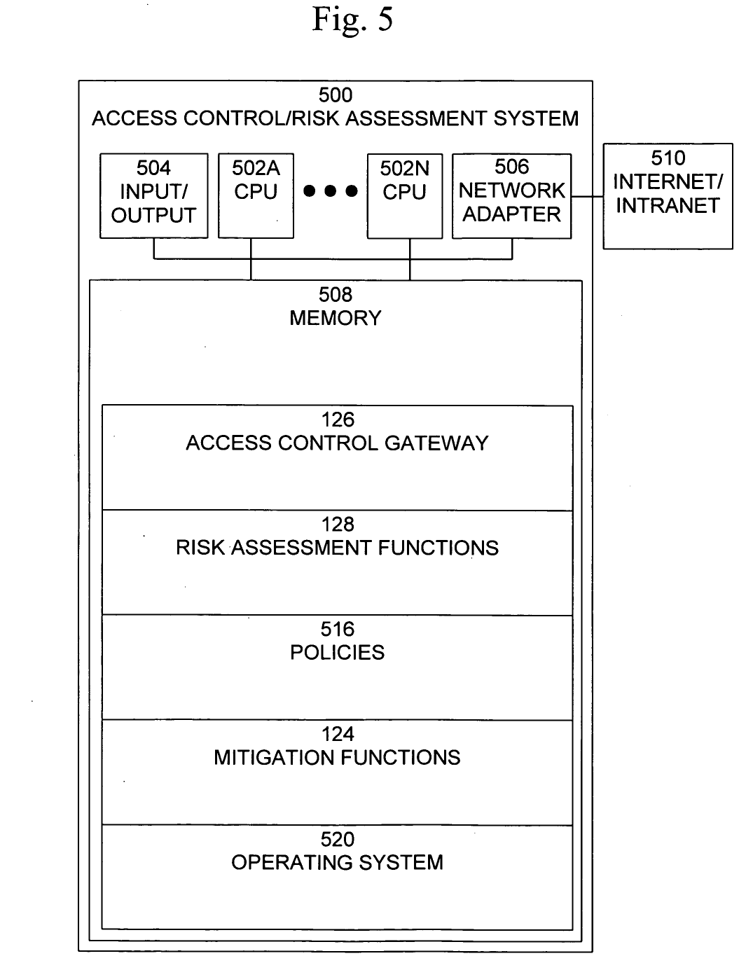

An exemplary block diagram of an access control/risk assessment system 500, in which the present invention may be implemented, is shown in FIG. 5. Access control/risk assessment system 500 is typically a programmed general-purpose computer system, such as a personal computer, workstation, server system, and minicomputer or mainframe computer. Access control/risk assessment system 500 includes one or more processors (CPUs) 502A-502N, input/output circuitry 504, network adapter 506, and memory 508. CPUs 502A-502N execute program instructions in order to carry out the functions of the present invention. Typically, CPUs 502A-502N are one or more microprocessors, such as an INTEL PENTIUM® processor. FIG. 5 illustrates an embodiment in which access control/risk assessment system 500 is implemented as a single multi-processor computer system, in which multiple processors 502A-502N share system resources, such as memory 508, input/output circuitry 504, and network adapter 506. However, the present invention also contemplates embodiments in which access control/risk assessment system 500 is implemented as a plurality of networked computer systems, which may be single-processor computer systems, multi-processor computer systems, or a mix thereof.

Input/output circuitry 504 provides the capability to input data to, or output data from, access control/risk assessment system 500. For example, input/output circuitry may include input devices, such as keyboards, mice, touchpads, trackballs, scanners, etc., output devices, such as video adapters, monitors, printers, etc., and input/output devices, such as, modems, etc. Network adapter 506 interfaces access control/risk assessment system 500 with Internet/intranet 510. Internet/intranet 510 may include one or more standard local area network (LAN) or wide area network (WAN), such as Ethernet, Token Ring, the Internet, or a private or proprietary LAN/WAN.

Memory 508 stores program instructions that are executed by, and data that are used and processed by, CPU 502 to perform the functions of access control/risk assessment system 500. Memory 508 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 5, memory 508 includes access control gateway 126, risk assessment functions 128, policies 516, mitigation functions 124, and operating system 520. Access control gateway 126 may include functions such as authentication, authorization and audit. Authorization may be implemented using Role based access control, access control lists or a policy language such as XACML. Risk assessment functions 128 analyze devices that are connected to the network or that are attempting to connect to the network to determine the risk factors associated with continuing connection of the device or allowing connection of the device. Policies 516 include rules for computer network access, and lays out the basic architecture of the network security environment. The policy includes a hierarchy of access permissions; that is, grant users access only to what is necessary for the completion of their work. Mitigation functions 124 may work in conjunction with risk assessment functions 128 in order to mitigate risks identified by risk assessment functions 128 and lower the resulting overall risk. Operating system 520 provides overall system functionality.

As shown in FIG. 5, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for controlling access to a network, comprising the steps of:
detecting that a device is attempting to obtain access to the network;
examining historical information relating to behavior of the device while the device was not accessing the network; and
determining whether to grant access to the network based on the historical information.

2. The method of claim 1, wherein the historical information relates to at least one of:
use of elevated privileges on the device, installation of software on the device, use of specified tools on the device, use of one or more protocols on the device, access to Internet domains on the device, temporary disabling of security software on the device, modification of the settings of security software on the device, modifying specified system settings on the device, attachment of external devices to the device, use of removable media with the device, information that the device was never turned on or used while disconnected, modification of an executable type file on the device, and receipt of a security notice from one or more security processes on the device.

3. The method of claim 1, further comprising the steps of:
identifying at least one risk factor based on the historical information;
assigning a score to each identified risk factor; and
generating a final risk score from the scores assigned to each identified risk factor.

4. The method of claim 3, wherein the determining step comprises the step of:
denying access to the network if the final risk score is greater than a threshold.

5. The method of claim 3, further comprising the steps of:
performing a mitigation process for each identified risk factor;
determining whether the mitigation process was successful for the risk factor; and
eliminating the score for the risk factor if the mitigation process was successful.

6. The method of claim 5, wherein the mitigation process comprises at least one of:
running at least one deep security scans on the device using updated versions of the security software for the device, running at least one deep security scans of only the changed files/setting of the device using updated versions of the security software for the device, quarantining the device until manual mitigation can be applied, and tightening a security policy for the device to a higher level based on the score but still allowing the device some access to the managed network.

7. A system for controlling access to a network comprising:
a processor operable to execute computer program instructions;
a memory operable to store computer program instructions executable by the processor; and
computer program instructions stored in the memory and executable to perform the steps of:
detecting that a device is attempting to obtain access to the network;
examining historical information relating to behavior of the device while the device was not accessing the network; and
determining whether to grant access to the network based on the historical information.

8. The system of claim 7, wherein the historical information relates to at least one of:
use of elevated privileges on the device, installation of software on the device, use of specified tools on the device, use of one or more protocols on the device, access to Internet domains on the device, temporary disabling of security software on the device, modification of the settings of security software on the device, modifying specified system settings on the device, attachment of external devices to the device, use of removable media with the device, information that the device was never turned on or used while disconnected, modification of an executable type file on the device, and receipt of a security notice from one or more security processes on the device.

9. The system of claim 7, further comprising the steps of:
identifying at least one risk factor based on the historical information;
assigning a score to each identified risk factor; and
generating a final risk score from the scores assigned to each identified risk factor.

10. The system of claim 9, wherein the determining step comprises the step of:
denying access to the network if the final risk score is greater than a threshold.

11. The system of claim 9, further comprising the steps of:
performing a mitigation process for each identified risk factor;
determining whether the mitigation process was successful for the risk factor; and
eliminating the score for the risk factor if the mitigation process was successful.

12. The system of claim 11, wherein the mitigation process comprises at least one of:
running at least one deep security scans on the device using updated versions of the security software for the device, running at least one deep security scans of only the changed files/setting of the device using updated versions of the security software for the device, quarantining the device until manual mitigation can be applied, and tightening a security policy for the device to a higher level based on the score but still allowing the device some access to the managed network.

13. A computer program product for controlling access to a network comprising:
a computer readable storage medium;
computer program instructions, recorded on the computer readable storage medium, executable by a processor, for performing the steps of
detecting that a device is attempting to obtain access to the network;
examining historical information relating to behavior of the device while the device was not accessing the network; and
determining whether to grant access to the network based on the historical information.

14. The computer program product of claim 1, wherein the historical information relates to at least one of:
use of elevated privileges on the device, installation of software on the device, use of specified tools on the device, use of one or more protocols on the device, access to Internet domains on the device, temporary disabling of security software on the device, modification of the settings of security software on the device, modifying specified system settings on the device, attachment of external devices to the device, use of removable media with the device, information that the device was never turned on or used while disconnected, modification of an executable type file on the device, and receipt of a security notice from one or more security processes on the device.

15. The computer program product of claim 1, further comprising the steps of:
identifying at least one risk factor based on the historical information;
assigning a score to each identified risk factor; and
generating a final risk score from the scores assigned to each identified risk factor.

16. The computer program product of claim 3, wherein the determining step comprises the step of:
denying access to the network if the final risk score is greater than a threshold.

17. The computer program product of claim 3, further comprising the steps of:
performing a mitigation process for each identified risk factor;
determining whether the mitigation process was successful for the risk factor; and
eliminating the score for the risk factor if the mitigation process was successful.

18. The computer program product of claim 5, wherein the mitigation process comprises at least one of:
running at least one deep security scans on the device using updated versions of the security software for the device, running at least one deep security scans of only the changed files/setting of the device using updated versions of the security software for the device, quarantining the device until manual mitigation can be applied, and tightening a security policy for the device to a higher level based on the score but still allowing the device some access to the managed network.
